(19) United States
(12) Patent Application Publication
(10) Pub. No.: US 2024/0068115 A1
(43) Pub. Date: Feb. 29, 2024

(54) An electrolyzer comprising a catalyst supported on a nanostructure

(71) Applicant: Smoltek AB, GÖTEBORG (SE)

(72) Inventors: Vincent Desmaris, GÖTEBORG (SE); Fabian Wenger, GÖTEBORG (SE)

(21) Appl. No.: 18/259,623

(22) PCT Filed: Jan. 31, 2022
(86) PCT No.: PCT/EP2022/052176

§ 371 Date: Jun. 28, 2023

(30) Foreign Application Priority Data
Feb. 5, 2021 (SE) 2130036-3
Jun. 4, 2021 (SE) 2130154-4

(51) Int. Cl. C25B 11/065; C25B 9/23; C25B 11/032; C25B 11/037; C25B 11/054

(52) U.S. Cl. CPC C25B 11/065; C25B 9/23; C25B 11/032; C25B 11/037; C25B 11/054

(57) ABSTRACT

An electrolyzer comprising a first and a second electrode and an ion exchange membrane arranged in-between the first and the second electrode. Each electrode comprises a conductive element and a catalyst layer and at least one catalyst layer comprises a catalyst structure. The catalyst structure comprises a plurality of elongated nanostructures and a plurality of electrocatalyst particles attached to the plurality of elongated nanostructures, wherein the plurality of elongated nanostructures is arranged to control a position of the plurality of electrocatalyst particles relative to the ion exchange membrane.

### TECHNICAL FIELD

The present disclosure relates to devices used in electrolysis, particularly for the electrolysis of water.

### BACKGROUND

The production of hydrogen gas through the electrolysis of water is a promising technology both for replacing the production of hydrogen gas from fossil fuels and as a means of converting excess electrical energy from intermittent energy sources such as solar and wind power to chemical energy for storage. However, existing water electrolyzers suffer from problems related to the corrosive conditions within the electrolysis cell and the use of expensive catalysts. For electrolysis cells comprising ion exchange membranes it may be necessary to use catalysts comprising e.g., platinum or iridium, which entails a significant cost. Additionally, current electrolysis cells are limited in terms of the ion current per area through the cell. An improvement in this regard would result in increased production capability.

WO2018185617 discloses a water electrolyzer comprising platinum or platinum oxide as a catalyst for the electrolysis reactions.

Still, there is a need for improved water electrolyzers.

### SUMMARY

It is an object of the present disclosure to provide improved water electrolyzers, which inter alia, offer improved efficiency of electrocatalyst usage.

This object is at least in part obtained by an electrolyzer comprising a first and a second electrode and an ion exchange membrane arranged in-between the first and the second electrode. Each electrode comprises a conductive element and a catalyst layer and at least one catalyst layer comprises a catalyst structure. The catalyst structure comprises a plurality of elongated nanostructures and a plurality of electrocatalyst particles attached to the plurality of elongated nanostructures, wherein the plurality of elongated nanostructures is arranged to control a position of the plurality of electrocatalyst particles relative to the ion exchange membrane.

For efficient operation of an electrolyzer cell comprising an ion exchange membrane, it is important to ensure good contact between the electrocatalyst particles and the ion exchange membrane, as ions such as hydrogen ions or hydroxide ions must be able to travel between the catalyst particles and the membrane. Controlling the position of the electrocatalyst particles makes it possible to improve the contact between the electrocatalyst particles and the ion exchange membrane, which is an advantage.

The elongated nanostructures may extend generally along respective axes, where the axes are oriented in parallel to each other and extend perpendicularly to the conductive element. The elongated nanostructures, extending along axes parallel to each other and substantially perpendicular to the conductive element, form a catalyst support structure that facilitates transport of the reactants and products of the chemical reaction and allows for efficient use of the available electrocatalyst particles, which is an advantage.

This means that the electrocatalyst particles attached to the elongated nanostructures form a layer of catalyst particles that can all simultaneously be positioned in close proximity to the ion exchange membrane. A larger fraction of the catalyst particles will then simultaneously be in close proximity to the ion exchange membrane compared to a configuration where the axes are not oriented in parallel, leading to an increase in efficiency without the need to use more catalyst particles. Alternately, a smaller amount of catalyst particles can be used without a reduction in efficiency.

The elongated nanostructures may comprise carbon nanostructures. Advantageously, carbon nanostructures have good electrical conductivity and structural stability, thereby providing both control over the position of the catalyst particle and a good electrical connection between the electrocatalyst particles and other components of the electrolyzer cell such as porous transport layers or conductive elements. This is beneficial for efficient electrolyzer operation. As an example, the elongated carbon nanostructures may comprise any of carbon nanofibers, carbon nanotubes, carbon nanosheets, and/or carbon nanowires.

Carbon nanofibers, as well as carbon nanotubes and nanowires, have the advantage of being easy to grow on a wide range of substrates.

In particular, for carbon nanofibers, the shape and surface structure can be altered by adjusting the conditions under which the nanofibers are grown. This provides the possibility of creating a plurality of nanofibers that are arranged in a particularly suitable configuration. They are also structurally and chemically robust.

The process of growing carbon nanostructures may entail the use of a growth catalyst to promote the formation of the carbon nanostructures. Advantageously, the growth catalyst used to grow carbon nanofibers may comprise the same materials as the catalyst particles used to promote the chemical reactions comprised in the electrolysis process. If the same materials can be used as a growth catalyst and as electrolysis catalyst particles, fabrication of the electrolyzer may be made simpler and more efficient.

To prevent degradation of the elongated nanostructures, at least one section of an elongated nanostructure may be covered by a protective coating arranged to increase a resistance to corrosion. The chemical environment at the electrodes of an electrolyzer is corrosive, especially at the anode side of the ion exchange membrane.

By coating the elongated nanostructures with a corrosion-resistant material, it is possible to prevent or slow degradation of the catalyst structure and increase the lifetime of the electrolyzer, which is an advantage. The protective coating may comprise any of platinum, iridium, titanium, and titanium nitride, or a combination thereof.

According to aspects, the elongated nanostructures may be grown on a first substrate and transferred to a second substrate comprising a component of the electrolyzer such as a conductive element or a porous transport layer. The elongated nanostructures may thus be grown on a substrate arranged for nanostructure growth and subsequently transferred to a substrate that is arranged for use in the electrolyzer. This means that the second substrate does not have to be suitable for nanostructure growth, which is an advantage.

According to other aspects, the elongated nanostructures may be grown on a substrate comprising a component of the electrolyzer such as a conductive element or a porous transport layer. Advantageously, this provides good contact between the nanostructures and said electrolyzer component.

The substrate may comprise a structured surface, and the elongated nanostructures may be grown on the structured surface. That is, the nanostructures may be grown on a patterned or rough surface such as a patterned flow plate or a porous diffusion layer, thereby improving the electrical contact between components of the electrolyzer. A surface of the ion exchange membrane may be arranged to follow a contour of the structured surface in order to ensure close contact between the catalyst structure and the ion exchange membrane.

According to aspects, at least one of the elongated nanostructures may be arranged to extend at least partially into the ion exchange membrane.

Advantageously, allowing the elongated nanostructures to extend into the ion exchange membrane improves the contact between the ion exchange membrane and the electrocatalyst particles. The transport of ions to and from the surface of the electrocatalyst particles is thus improved, which makes the catalyst structure and the electrolyzer more efficient.

At least one electrocatalyst particle may be affixed to a first section of the at least one elongated nanostructure. At least this first section of the at least one elongated nanostructure may then extend into the ion exchange membrane. Preferably, the first section of the at least one elongated nanostructure is located at an end of the at least one elongated nanostructure opposite from the conductive element.

In other words, electrocatalyst particles can be attached to a section near the tip of an elongated nanostructure, and this section is then embedded in the ion exchange membrane. This allows for efficient use of the available electrocatalyst particles, as they are placed in good contact with the ion exchange membrane, while the part of the elongated nanostructures that is not embedded may facilitate transport of water and/or gases to and from the electrocatalyst particles.

It may be that the elongated nanostructures are not all the same length, or they may be of substantially the same length but grown on an uneven substrate such as a porous metal or carbon material, leading to the tips of the elongated nanostructures being at different distances relative to the conductive element. Thus, a distance from the conductive element to an end of an elongated nanostructure opposite from the conductive element may vary among the elongated nanostructures. Elongated nanostructures for which the distance is larger may extend further into the ion exchange membrane than elongated nanostructures for which the distance is smaller, such that all elongated nanostructures extend at least partially into the ion exchange membrane. This ensures that electrocatalyst particles on all elongated nanostructures may be placed in close proximity to the membrane, which is an advantage.

According to one example, the first section may comprise more than 90% of the at least one elongated nanostructure. According to another example, the first section may comprise less than half of the at least one elongated nanostructure. According to a third example, the first section may comprise between 50% and 90% of the at least one elongated nanostructure.

The electrocatalyst particles can be attached to the elongated nanostructures using a deposition method that is an indirect or direct physicochemical and/or physical method. Examples of such methods include electrochemical deposition, electroless deposition, sputtering, spray-coating, dip-coating, and/or solvent casting.

At least one electrode may comprise a porous transport layer arranged between the conductive element and the catalyst structure. The porous transport layer comprises a porous material. A porous transport layer may improve the transport of water and/or gases to and from the catalyst structure, which is an advantage.

The object is also obtained at least in part by an electrolyzer comprising a first and a second electrode and an ion exchange membrane arranged in-between the first and second electrode. Each electrode comprises a conductive element and at least one of the electrodes comprises a catalyst structure. The catalyst structure comprises a plurality of elongated nanostructures arranged to connect the conductive element to the plurality of electrocatalyst particles, where each electrocatalyst particle is localized at an end of a respective elongated nanostructure opposite from the conductive element.

Advantageously, each catalyst particle being localized at an end of a respective elongated nanostructure provides an improved control over the position of the catalyst particles relative to the ion exchange membrane and other components of the electrolyzer, which makes it possible to achieve a more efficient operation. As an example, the catalyst particles need to be in close proximity to the ion exchange membrane and present a large surface area in order to efficiently promote the chemical reactions comprised in the electrolysis process. With improved control over the position of the catalyst particles, both the distance to the ion exchange membrane and the exposed surface area can be adjusted to improve performance.

Advantageously, since a larger fraction of the catalyst particles can be reliably positioned close to the ion exchange membrane, the total number of catalyst particles used can be reduced compared to electrolyzers where the catalyst structure does not afford the same degree of control over the position of catalyst particles. In other words, in the electrolyzer disclosed here a smaller amount of catalyst particles may be used to achieve the same efficiency as in previously known electrolyzers.

According to one example, the electrocatalyst particles may be positioned less than 10 nm from the ion exchange membrane, and preferably less than 5 nm from the ion exchange membrane. According to another example, electrocatalyst particles may be positioned in contact with the ion exchange membrane, or within 0.1 to 1 nm from the ion exchange membrane. Advantageously, positioning the catalyst particles in close proximity to the ion exchange membrane, i.e., less than 10 nm, and preferably closer, allows more efficient use of the catalyst particles, as the hydrogen or hydroxide ions generated during the reactions can more easily enter the ion exchange membrane. Also, hydrogen or hydroxide ions exiting the ion exchange membrane can more easily adsorb to a catalyst particle, which is important for the electrolysis reactions

At least one of the elongated nanostructures may be a branched nanostructure comprising a trunk and at least two branches, where an electrocatalyst particle is localized at the end of each branch. Advantageously, branched nanostructures make it possible to increase the number of catalyst particles per unit area of the ion exchange membrane, thereby increasing the surface area of catalyst where the electrolysis reactions may take place. The catalyst structure may also comprise a porous carbon material.

The object is further obtained at least in part by a method of producing a catalyst structure for an electrolyzer. The electrolyzer comprises a first and a second electrode and an ion exchange membrane arranged in-between the first and the second electrode. Each electrode comprises a conductive element. The method comprises generating a plurality of elongated nanostructures, where the elongated nanostructures are connected to the conductive element comprised in the first or second electrode, and attaching a plurality of electrocatalyst particles to the plurality of elongated nanostructures such that each electrocatalyst particle is localized at an end of a respective elongated nanostructure opposite from the conductive element comprised in the first or second electrode.

Advantageously, the elongated nanostructures being connected to the conductive element ensures good electrical contact between the conductive element and the catalyst particles, which is important for efficient electrolyzer operation. Each catalyst particle being localized at an end of a respective elongated nanostructure provides control over the position of the catalyst particle, e.g., in relation to the ion exchange membrane.

Generating a plurality of elongated nanostructures may comprise growing the elongated nanostructures on a substrate, such as one of the conductive elements comprised in the first or second electrode, a porous transport layer, or some other substrate. Growing the elongated nanostructures on a substrate presents the advantage that the properties and shape of the nanostructures can be tailored by tuning the conditions under which the nanostructures are grown, in order to improve the functionality of the resulting catalyst structure. As an example, the thickness of the elongated nanostructures could be tuned to improve structural stability. As another example, the surface of the nanostructures could be altered to include structures such as ridges and grooves, which increases the total surface area and may provide more possible sites at which catalyst particles may be attached.

Growing the elongated nanostructures on a substrate may comprise depositing a growth catalyst layer on a surface of the substrate and growing the elongated nanostructures on the growth catalyst layer. The growth catalyst layer promotes growth of the elongated nanostructures. By altering the properties of the growth catalyst layer, the properties of the grown elongated nanostructures can be tuned in order to improve the functionality of the resulting catalyst structure.

According to aspects, depositing a growth catalyst layer may comprise depositing a uniform growth catalyst layer and introducing a pattern onto the deposited uniform growth catalyst layer. An advantage of introducing a pattern onto the deposited uniform growth catalyst layer is that it makes it possible to control the density of nanostructures per surface area on the substrate. The density of nanostructures per surface area may affect the flow of fluids such as water, oxygen gas, and hydrogen gas to and from the catalyst particles. It may also affect the density of catalyst particles per surface area of the membrane. Both the flow and the catalyst particle density impact the efficiency of the electrolyzer. As such, controlling the density of nanostructures per surface area of the substrate makes it possible to improve the efficiency of the electrolyzer.

Growing the elongated nanostructures on a substrate may also comprise depositing a conducting layer on a surface of the substrate. Advantageously, depositing a conducting layer on the surface of the substrate can produce the effect of electrically grounding the substrate. Electrically grounding the substrate may be advantageous for certain methods of growing nanostructures. If a conductive layer is deposited on a surface of the substrate and a growth catalyst layer is deposited on top of the conductive layer, the conductive layer may also hinder diffusion of atoms and/or molecules between the growth catalyst layer and the substrate.

There is also herein disclosed a method of producing a catalyst structure for an electrolyzer. The electrolyzer comprises a first and a second electrode, and an ion exchange membrane arranged in-between the first and the second electrode. Each electrode comprises a conductive element. The method comprises configuring a substrate having a surface. The substrate may be one of the conductive elements comprised in the first or second electrode, a porous transport layer, or some other substrate. The method further comprises selecting a growth catalyst for the growth of elongated nanostructures on the substrate, such that the growth catalyst can also be used as an electrolysis catalyst in the electrolyzer, and depositing a growth catalyst layer comprising the selected growth catalyst on the surface of the substrate. The method also comprises generating elongated nanostructures with a catalyst particle suitable for use in an electrolyzer localized at an end of each elongated nanostructure by growing elongated nanostructures on the growth catalyst layer.

In addition to the advantages described above associated with growing elongated nanostructures on a substrate using a catalyst layer, this method presents the further advantage of using a growth catalyst that can also be used as an electrolysis catalyst in an electrolyzer. This makes it possible to produce the catalyst structure in a simpler and more efficient way.

According to aspects, depositing a growth catalyst layer may comprise depositing a uniform growth catalyst layer and introducing a pattern onto the deposited uniform growth catalyst layer. An advantage of introducing a pattern onto the deposited uniform growth catalyst layer is that it makes it possible to control the density of nanostructures per surface area on the substrate. The density of nanostructures per surface area may affect the flow of fluids such as water, oxygen gas, and hydrogen gas to and from the catalyst particles. It may also affect the density of catalyst particles per surface area of the membrane. Both the flow and the catalyst particle density impact the efficiency of the electrolyzer. As such, controlling the density of nanostructures per surface area of the substrate makes it possible to improve the efficiency of the electrolyzer.

According to other aspects, depositing a growth catalyst layer on the surface of the substrate may comprise depositing a conducting layer on the surface of the substrate. Advantageously, depositing a conducting layer on the surface of the substrate can produce the effect of electrically grounding the substrate. Electrically grounding the substrate may be advantageous for certain methods of growing nanostructures. If a conductive layer is deposited on a surface of the substrate and a growth catalyst layer is deposited on top of the conductive layer, the conductive layer may also hinder diffusion of atoms and/or molecules between the catalyst layer and the substrate.

There is furthermore herein described a method of producing a catalyst structure for an electrolyzer. The electrolyzer comprises a first and a second electrode, and an ion exchange membrane arranged in-between the first and the second electrode. Each electrode comprises a conductive element. The method comprises generating a plurality of elongated nanostructures, attaching a plurality of catalyst particles to the plurality of elongated nanostructures, and arranging the plurality of elongated nanostructures to control a position of the plurality of electrocatalyst particles relative to the ion exchange membrane.

The methods disclosed herein are associated with the same advantages as discussed above in connection to the different apparatuses. Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated. Further features of, and advantages with, the present invention will become apparent when studying the appended claims and the following description. The skilled person realizes that different features of the present invention may be combined to create embodiments other than those described in the following, without departing from the scope of the present invention.

### BRIEF DESCRIPTION OF THE DRAWINGS

The present disclosure will now be described in more detail with reference to the appended drawings, where:

FIG. 1 schematically illustrates a water electrolyzer;

FIGS. 2 A, B and C schematically illustrate elongated nanostructures on a substrate;

FIG. 3 schematically illustrates a catalyst structure;

FIG. 4 schematically illustrates a water electrolyzer;

FIGS. 5A, B and C are flow charts illustrating methods; and

FIGS. 6A and B are electron microscope images of carbon nanofibers.

### DETAILED DESCRIPTION

Aspects of the present disclosure will now be described more fully with reference to the accompanying drawings. The different devices and methods disclosed herein can, however, be realized in many different forms and should not be construed as being limited to the aspects set forth herein. Like numbers in the drawings refer to like elements throughout.

The terminology used herein is for describing aspects of the disclosure only and is not intended to limit the invention. As used herein, the singular forms “a”, “an” and “the” are intended to include the plural forms as well, unless the context clearly indicates otherwise.

Although the following description is focused on electrolyzers suitable for the electrolysis of water, a person skilled in the art will realize that the devices and methods herein described can also be used for electrolysis of other liquids or gases, provided that the reduction and oxidation reactions comprised in the electrolysis process take place on the surface of a catalyst and that the electrodes are separated by a solid electrolyte.

An electrolyzer comprises two electrodes, of which one is the positively charged anode and one is the negatively charged cathode, and a medium which allows for transport of ions, known as an electrolyte. The electrodes are connected to a power supply which provides electrical energy, driving the electrolysis reaction.

In some electrolyzers, a solid electrolyte or ion exchange membrane is used as the ion transport medium. An ion exchange membrane is a solid material that can be traversed by ions. Since this material conducts ions it can also be known as an ionic conductor. Use of ion exchange membranes allows for a compact electrolyzer design, as well as good separation of oxygen and hydrogen gas, which is an advantage.

The ion exchange membranes used in electrolyzers can be categorized according to the ionic species moving through the membrane. Anion exchange membranes, AEM, conduct the negative anion, in this case the hydroxide ion, from the cathode to the anode. Proton exchange membranes, PEM, conduct the positive hydrogen ion or proton from the anode to the cathode. Both anion and proton exchange membranes may be permeable to water but minimize the amount of hydrogen and/or oxygen gas that travels between the electrodes.

In electrolyzers comprising ion exchange membranes, each electrode comprises an electrically conductive element connected to the power source and a catalyst layer comprising an electrolysis catalyst that facilitates the chemical reactions comprised in the electrolysis process. Most electrolyzer electrodes also comprise a porous transport layer, which facilitates the transport of products and reactants to and from the catalyst, arranged between the conductive element and the catalyst layer.

Herein, a conductive element is an element that has a high electric conductivity. A high electric conductivity could be an electric conductivity normally associated with metallic or semiconducting materials, or an electric conductivity of more than 100 (Ωm)⁻¹.

A catalyst is a material or chemical compound that facilitates a chemical reaction, e.g., by lowering the amount of energy needed to start the chemical reaction. An electrolysis catalyst facilitates chemical reactions comprised in the electrolysis process, such as the reaction taking place at the anode side or the reaction taking place at the cathode side. The anode- and cathode-side electrolysis catalysts will frequently comprise different materials.

During electrolysis, water can enter the electrolyzer on the side of the ion exchange membrane where the anode is located. For a PEM electrolyzer, water molecules that come into contact with the electrolysis catalyst on the anode side undergo the oxygen evolution reaction:

2H₂O→4H⁺+O₂+4e⁻.

The electrons will enter the circuit connecting the two electrodes, the oxygen gas leaves the electrolyzer, and the protons will diffuse across the PEM to the cathode side and the cathode electrolysis catalyst, where they undergo the hydrogen evolution reaction:

4H⁺+4e⁻→2H₂.

In an AEM electrolyzer, the water molecules can instead first diffuse through the AEM to the cathode side, where the following reaction takes place at the cathode electrolysis catalyst:

2H₂O+2e⁻→2OH⁻+H₂.

The hydroxide ions will diffuse through the AEM and undergo the following reaction at the anode electrolysis catalyst:

4OH⁻−4e⁻→O₂+2H₂O.

The electrochemical reactions in the cell take place at the electrocatalyst surface and achieving a high reaction rate therefore places a number of requirements on the catalyst layer and its connection to other parts of the cell. Firstly, water must be able to reach the anode-side catalyst and gases (hydrogen or oxygen depending on the electrode) must be able to diffuse away from the catalysts. Secondly, as the electrochemical reactions either generate or consume ions and electrons, the catalyst must be electrically connected to the power source, which among other things requires the contact resistance between catalyst layer and the porous transport layer as well as between the porous transport layer and the conductive element to be low.

The electrochemical reactions take place at the catalyst surface but depending on the structure of the catalyst layer only part of the catalyst surface may contribute. For the reactions to proceed efficiently the catalyst surface must be in contact with both the membrane, allowing ion transport to or from the catalyst, and the surrounding water and gas that allows for transport of reactants and products. This is sometimes described as the reaction occurring at the three-phase boundary between membrane, water or gas, and catalyst. The surface area where these conditions are met is the active catalyst surface area, and the catalyst layer needs to be structured to make it as large as possible. Like all components of the electrolyzer cell, the catalyst layer must also be chemically stable.

In practice, catalyst layers often contain nanoparticles of the catalytically active material such as platinum or iridium oxide. Such particles will henceforth be referred to as catalyst particles or electrocatalyst particles. The electrocatalyst particles may be either unsupported or dispersed on a porous catalyst support such as carbon black, a titanium mesh, or a metal oxide. Thin films of catalytically active material sputtered onto nanostructured supports may also be used. In general, the catalyst support structure needs to be able to conduct electricity in addition to being chemically stable under the conditions present in the electrolyzer. The catalyst layer also often comprises an ionically conducting polymer in order to improve the transport of ions to and from the catalyst particles. Usually, the membrane and the catalyst layers are fabricated together in what is known as a membrane-electrode assembly (MEA).

Catalyst supports used today, such as carbon black, typically have an irregular porous structure. However, more regular nanostructured supports made from nanowires, nanowhiskers, nanofibers, and nanotubes may also be used. A catalyst support with a more regular structure can enable better control over the placement of the catalyst, leading to better contact between the catalyst and the membrane, as well as improving transport of water and of oxygen gas and hydrogen gas.

The layer between the conductive plate and the catalyst layer, known e.g. as the diffusion layer, porous transport layer, or the current collector, faces a similar set of requirements, except for the need for ionic conductivity. The diffusion layer serves to connect the catalyst layer to the conductive plate in order to allow electric current to flow between the power source and the catalyst, while also allowing mass transport of the reactants and products of the electrolysis reaction, i.e., water, oxygen, and hydrogen. It can also serve as a heat conductor and as a mechanical support for the MEA. Carbon paper or carbon felt are often used on the cathode side, while porous metal structures are more often used on the anode side due to the harsher chemical conditions. In PEM cells this often means a titanium mesh, while in AEM cells the anode-side diffusion layer may be a nickel foam.

For optimal operation of an ion exchange membrane electrolyzer, the electrolysis catalyst needs to be in close proximity to the ion exchange membrane so that protons or hydroxide ions can easily enter the ion exchange membrane. As electron transport to and from the electrolysis catalyst is essential for the reactions, the electrolysis catalyst also needs to be in electrical contact with the conductive elements. Additionally, the electrolysis catalyst must have enough exposed surface area that water molecules or ions can easily adsorb to it and gas molecules can desorb.

If the electrolysis catalyst comprises catalyst particles supported by a support structure, any catalyst particle that is too far from the ion exchange membrane or has poor electric contact with the conductive element will contribute little or not at all to the electrolysis reactions, thereby lowering the efficiency of the electrolyzer. It is thus an advantage to be able to control the position of the electrocatalyst particles.

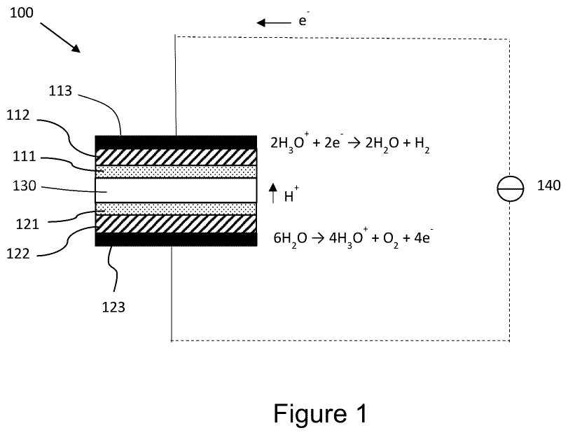

FIG. 1 shows an electrolyzer 100 comprising a first and a second electrode and an ion exchange membrane 130 arranged in-between the first and the second electrode.

Each electrode comprises a conductive element 113, 123, and a catalyst layer 111, 121, the catalyst layer being arranged in close contact with the ion exchange membrane 130. Both conductive elements 113, 123 are connected to a power source 140.

A least one electrode may also comprise a porous transport layer 112, 122 arranged between the conductive element 113, 123 and the catalyst layer 111, 121 as shown in FIG. 1. The porous transport layer comprises a porous material.

Here, the conductive elements 113, 123 comprise conductive materials that can withstand the chemical environment in the electrolyzer. The conductive elements 113, 123 may for example comprise materials such as titanium, tungsten, and/or zirconium. Optionally, a conductive element may be a steel element coated with one or a combination of titanium, tungsten, and zirconium. A conductive element may also comprise a carbon composite material.

The conductive element may also be known as a separator element, separator plate, or flow plate. If the electrolyzer cell is part of a stack of electrolyzer cells arranged in series, a conductive element may serve as the anode-side conductive element for one electrolyzer cell and as the cathode-side conductive element for a neighboring electrolyzer cell. In this case it may be referred to as a bipolar plate.

As an example, the conductive elements 113, 123 may be conductive plates. A plate is taken to mean an object that is extended in two dimensions and comparatively thin in the third dimension. The conductive elements 113, 123 may also be in the shape of a sheet, or other structure suitable for electrolysis.

The ion exchange membrane 130 comprises ionic conductors, i.e., materials through which ions can travel. As an example, the ionic conductor may be a polymer such as sulfonated tetrafluoroethylene, also known as Nafion, or polymers based on polysulfone or polyphenole oxide. However, the ion exchange membrane may also comprise other types of ionic conductors, for example metal oxides such as doped barium zirconate, doped barium cerate, doped lanthanum gallate, or stabilized zirconia.

The porous transport layer 112, 122 comprises porous, electrically conductive materials such as a titanium mesh or nickel foam, or it may comprise porous carbon materials such as carbon paper or carbon felt. The porous transport layer may be a planar or plate-shaped layer arranged parallel with the conductive element.

The catalyst particles comprise materials that are catalytically active and promote the reactions taking place at the cathode and anode during electrolysis. As an example, the catalyst particles may comprise platinum, ruthenium, palladium, or iridium. The catalyst particles may also comprise metal oxides such as platinum oxide or iridium oxide. As another example, the catalyst particles may comprise cobalt or nickel. Optionally the catalyst particles may be nanoparticles, i.e., have a size that is substantially smaller than one micrometer and mostly between 1 and 100 nm. Preferably, the catalyst particles may be between 3 and 10 nm in size.

In addition to the catalyst particles, the catalyst layer 112, 122 may comprise a catalyst support comprising electrically conductive materials. The catalyst support may for example comprise carbon black, carbon nanofibers, carbon nanotubes, or porous carbon materials. Metallic materials such as a porous titanium mesh or nickel foam may also be used. The catalyst layer may also comprise ionically conducting materials such as sulfonated tetrafluoroethylene.

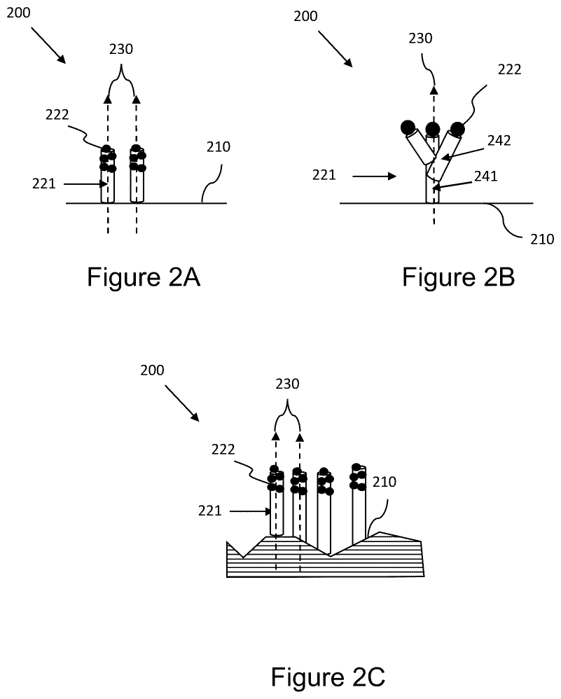

According to the present disclosure, at least one of the catalyst layers 111, 121 comprised in the first and second electrode of the electrolyzer 100 comprises a catalyst structure comprising a plurality of elongated nanostructures, as shown schematically in FIGS. 2A, B and C. The catalyst structure comprises a plurality of elongated nanostructures 221 and a plurality of electrocatalyst particles 222 attached to the plurality of elongated nanostructures 221. The plurality of elongated nanostructures 221 is arranged to control a position of the plurality of electrocatalyst particles 222 relative to the ion exchange membrane 130. Controlling the position of the electrocatalyst particles 222 relative to the ion exchange membrane 130 could for example mean positioning the electrocatalyst particles within a certain distance from the ion exchange membrane 130, or in contact with the ion exchange membrane 130.

A nanostructure is a structure having a size that is substantially smaller than one micrometer, and preferably between 1 and 100 nm, in at least one dimension. Herein, an elongated nanostructure is a nanostructure that is substantially larger in at least one dimension, such as height, compared to another dimension such as width or depth. As an example, consider a substantially cylindrical nanostructure characterized by a height and a radius. The nanostructure may be considered elongated if the height is significantly larger than the radius, e.g., if the height is more than twice as large as the radius. Similar reasoning may be applied to nanostructures that are substantially conical, rectangular, or of arbitrary shape.

The elongated nanostructures 221 may for example be straight, spiraling, branched, wavy or tilted. Optionally, they may be classifiable as nanowires, nano-horns, nanotubes, nano-walls, crystalline nanostructures, or amorphous nanostructures.

Since the nanostructures comprised in the catalyst structure 200 are elongated nanostructures, they are larger in one dimension than in other dimensions. Consider an axis along this dimension as the height axis of the nanostructure. If this height axis extends perpendicularly or nearly perpendicularly to the conductive element 113, 123 and/or the porous transport layer 112, 122, the elongated nanostructures 221 can be considered as extending generally along respective axes 230 that are oriented in parallel to each other and perpendicularly to the conductive element 113, 123, or the porous transport layer 112, 122.

This is shown in FIGS. 2A, B, and C, which schematically illustrate elongated nanostructures 221 extending along respective axes 230 that are parallel to each other and perpendicular to a substrate 210. The substrate may be a conductive element 113, 123, a porous transport layer 112, 122, or some other substrate. FIGS. 2A and 2C show elongated nanostructures with a cluster of electrocatalyst particles 222 attached at the upper end of the elongated nanostructure, while FIG. 2B shows a branched elongated nanostructure with an electrocatalyst particle attached to the end of each branch.

This should not be taken to mean that the nanostructures are completely straight or completely perpendicular to the conductive element 111, 121, as they can for example have a moderate tilt relative to the axis 230, or they may curve back and forth to form a spiraling or wavy shape. Rather, the nanostructures extend in the general direction of the axis 230. In this context, a moderate tilt means that the angle between the height axis and the axis 230 is less than 45 degrees, and preferably may be less than 30 degrees, even more preferably less than 10 degrees.

According to aspects, the plurality of elongated nanostructures 221 may comprise carbon nanostructures. For example, elongated carbon nanostructures may comprise any of carbon nanofibers, carbon nanotubes, carbon nanosheets, and/or carbon nanowires. The elongated nanostructures 221 may also comprise a combination of two or more of carbon nanofibers, carbon nanotubes, and/or carbon nanowires. As an example, an elongated carbon nanostructure could comprise carbon nanotubes attached to a carbon nanofiber. An elongated carbon nanostructure could also be a graphene wall or carbon nanosheet.

Carbon nanofibers (CNF) are elongated carbon nanostructures with diameters between 1 and 100 nm and lengths from 0.1 to 100 μm. For carbon nanofibers, the shape and surface structure can be tuned by adjusting the conditions under which the nanofibers are grown in order to improve the functionality of the resulting catalyst structure 200. As an example, the thickness of the nanofibers could be tuned to improve structural stability. It is also possible to grow nanofibers that are arranged in a configuration that is particularly suitable for the catalyst structure 200, e.g., with regard to the density of nanofibers per surface area, or the orientation of the nanofibers.

It is also possible to tune the available surface area or the number of carbon atoms per surface area. As an example, carbon nanofibers may be partly formed by amorphous carbon, resulting in a higher number of carbon atoms per surface area.

This may result in a larger number of possible sites where catalyst particles 222 can be attached. A similar effect may be achieved if the carbon nanofibers have a corrugated surface structure. Herein, a corrugated surface structure is taken to mean that a surface has a series of grooves and ridges of similar or different sizes.

Furthermore, the process of growing carbon nanofibers may involve the use of a growth catalyst that promotes formation of carbon nanofibers. The growth catalyst may comprise materials that are also comprised in the catalyst particles used to promote the chemical reactions comprised in the electrolysis process. If the same material can be used as a growth catalyst and as an electrolysis catalyst forming catalyst particles, fabrication of the electrolyzer may be made simpler and more efficient.

According to other aspects, the elongated nanostructures 221 may comprise copper, aluminum, silver, gallium arsenide, zinc oxide, indium phosphate, gallium nitride, indium gallium nitride, indium gallium arsenide, silicon, or other materials.

The chemical environment in an electrolyzer may be corrosive, especially on the anode side due to the high electrical potential. To prevent degradation of the catalyst structure 200, the elongated nanostructures 221 may be shielded from the surrounding chemical environment. For example, at least one section of an elongated nanostructure 221 may be covered by a protective coating arranged to increase a resistance to corrosion. As an example, the protective coating may comprise any of platinum, iridium, titanium, niobium, and titanium nitride, or a combination thereof. As another example, the protective coating may comprise ceramic materials or metal oxides such as aluminum oxide, cerium oxide and zirconium oxide.

According to aspects, the surface of the elongated nanostructures 221 may also be chemically altered to achieve hydrophobic or hydrophilic surface properties. This may be achieved through a number of methods such as coating, etching, or chemical functionalization.

At least one of the elongated nanostructures 221 may be arranged to extend at least partially into the ion exchange membrane 130. For an elongated nanostructure to be extended at least partially into the ion exchange membrane may mean that the nanostructure extends past the surface of the membrane by at least 5% of its length.

This results in a large active surface area or three-phase boundary, where the electrocatalyst is in good contact with the membrane as well as with the reactants of the electrochemical reaction. Due to this large active surface area it may be possible to reduce the necessary catalyst load.

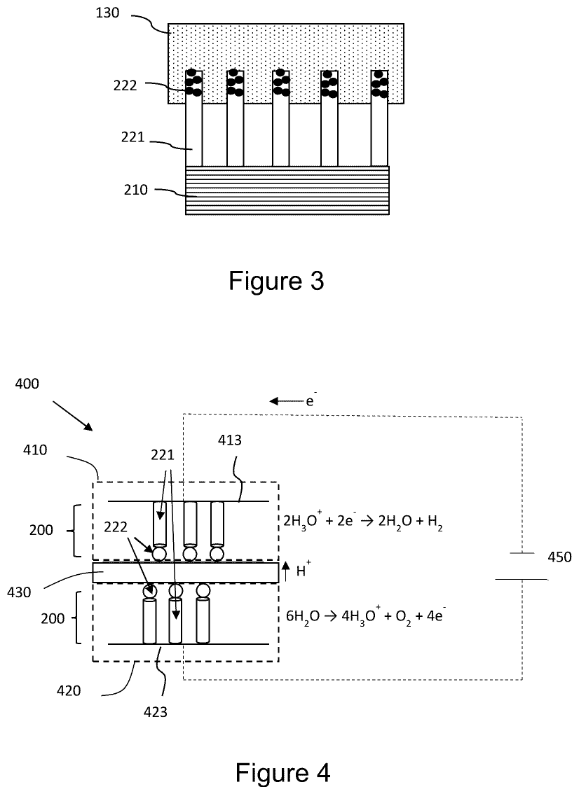

At least one electrocatalyst particle 222 may be affixed to a first section of the at least one elongated nanostructure 221. This first section of the elongated nanostructure 221 may then be positioned to place the electrocatalyst particle 222 in contact with the ion exchange membrane 130, or it may extend into the ion exchange membrane 130, as shown in FIG. 3. The first section of the at least one elongated nanostructure 221 may be located at an end of the at least one elongated nanostructure opposite from the conductive element 113, 123 and the porous transport layer 112, 122.

According to aspects, the first section may comprise at least 90% of the at least one elongated nanostructure 221. According to other aspects, the first section may comprise less than half of the at least one elongated nanostructure 221, or between 50% and 90% of the elongated nanostructure.

The electrocatalyst particles 222 may be attached to the elongated nanostructures 221 using a suitable deposition method. Examples of suitable deposition methods include indirect or direct physicochemical and/or physical methods, such as electrochemical deposition, electroless deposition, sputtering, spray-coating, dip-coating, and/or solvent casting.

One method of producing elongated nanostructures is to grow the elongated nanostructures on a substrate using methods such as chemical vapor deposition, CVD. CVD is a fabrication method where a precursor, typically a gas, is deposited on a substrate. On the substrate, it undergoes a reaction to form the fabricated material. Some types of CVD, such as plasma-enhanced CVD (PECVD) can be used to grow vertically oriented nanostructures, that is, nanostructures that extend generally perpendicularly from the surface of the substrate on which they are grown.

According to aspects, the elongated nanostructures 221 may be grown on a substrate comprising a component of the electrolyzer 100, such as a conductive element 113, 123 or a porous transport layer 112, 122. This results in an electrocatalyst structure 200 wherein the elongated nanostructures 221 are attached to and in good electrical contact with the component of the electrolyzer cell forming the substrate. As an example, the elongated nanostructures may be grown on a substrate so as to be vertically oriented, as described above, and subsequently incorporated into the electrolyzer such that they extend from the conductive element or diffusion layer towards the ion exchange membrane.

According to other aspects, the elongated nanostructures 221 may be grown on a first substrate and transferred to a second substrate comprising a component of the electrolyzer 100 such as a conductive element 113, 123 or a porous transport layer 112, 122. That is, the nanostructures can be grown on a substrate that is not in itself made part of the electrolyzer cell, but only serves as a growth substrate. This enables the use of a growth substrate optimized for nanostructure growth, without also needing to be suitable for use in the electrolyzer. Conversely, the second substrate may be optimized for use in the electrolyzer without needing to be suitable for nanostructure growth.

The substrate on which the elongated nanostructures 221 are grown may comprise a structured surface, and the elongated nanostructures 221 may be grown on the structured surface. Here, a structured surface is a surface that is not flat but displays e.g., holes, ridges, or bumps. This could be described as surface roughness, unevenness, or patterning. For example, the substrate may be a porous material which displays surface roughness due to pores intersecting with the material surface.

An uneven substrate may lead to the tips of the elongated nanostructures 221 reaching different heights relative e.g., to the conductive element 113, 123 even if the elongated nanostructures themselves are of a similar length. Thus, a distance from the conductive element 113, 123 to an end of an elongated nanostructure 221 opposite from the conductive element may vary between elongated nanostructures.

If the elongated nanostructures extend into the ion exchange membrane, elongated nanostructures for which the distance is larger may extend further into the ion exchange membrane than elongated nanostructures for which the distance is smaller, such that all elongated nanostructures extend at least partially into the ion exchange membrane. A surface of the ion exchange membrane 130 may be arranged to follow a contour of the structured surface.

As an example, carbon nanostructures such as carbon nanofibers can be grown using plasma-enhanced CVD (PECVD). When growing carbon nanostructures with PECVD, a carbon-containing gas such as methane or acetylene, known as the process gas, is introduced into the reactor along with an inert gas such as nitrogen or argon, and a reducing gas such as hydrogen or ammonia. In the reactor gases are converted into a plasma at a certain temperature, e.g. using AC or DC discharge between two electrodes. From the plasma reaction, carbon is deposited on the substrate.

In order for carbon nanofibers to form, a growth catalyst may need to be present on the surface of the substrate. Common growth catalyst materials are nickel, iron, cobalt, and palladium. The growth catalyst can be deposited in the form of a uniform layer, or it can be patterned using lithographic techniques. The growth catalyst may also be deposited in the form of nanoparticles, e.g. through spin-coating. If the growth catalyst is not already in the form of nanoparticles as it is deposited, it may form nanoparticles on the substrate through a process known as de-wetting. During the CVD process, carbon will be deposited on the growth catalyst particles and diffuse across the surface, eventually forming nanostructures such as nanofibers or nanotubes. For nanofibers and nanotubes, depending on parameters such as the size of the growth catalyst particle and the interaction between the growth catalyst and the substrate, the nanofiber will display either base growth or tip growth. During base growth, the nanofiber and/or nanotubes will grow upwards from the growth catalyst particle, which remains on the substrate. During tip growth the growth catalyst particle will remain at the tip of the nanofiber which grows under the growth catalyst particle.

Using PECVD to grow carbon nanofibers has several advantages. Unlike many other types of CVD, PECVD can be performed at temperatures down to around 350° C., making it possible to grow carbon nanofibers on substrates that cannot tolerate higher temperatures. PECVD can be used to produce vertically aligned carbon nanofibers, which extend mostly perpendicularly from the substrate. Also, by using a patterned catalyst it is possible to control the spacing between the nanofibers. Thus, it is possible to grow an array of nanofibers with well-defined widths and heights and a desired spacing between the fibers. Other properties of CVD-grown carbon nanofibers, such as mechanical properties and electrical resistivity, will vary depending on the exact growth conditions.

According to aspects, the structure and morphology of a plurality of CVD-grown carbon nanostructures such as carbon nanotubes and carbon nanofibers can be altered after growth of the nanostructures. This can be accomplished through methods such as liquid induced densification. During liquid induced densification, a liquid such as acetone, deionized water, or isopropyl alcohol is introduced onto the sample and then allowed to evaporate, causing the carbon nanostructures to form bundles and leaving larger spaces in between the bundles. Optionally, a second plurality of carbon nanostructures may be grown in the spaces between the bundles.

Using vertically aligned PECVD-grown carbon nanofibers as the elongated nanostructures 221 in the catalyst structure 200 gives better control over the position of the electrocatalyst particles. If the tips of the carbon nanofibers are selectively coated with catalyst particles, or even if the growth catalyst used for growing the carbon nanofibers is also useful as an electrolysis catalyst, positioning the tips of the carbon nanofibers either at the surface of the ion exchange membrane or embedded in the ion exchange membrane ensures good contact between the catalyst and the membrane. This leads to an efficient use of the available catalyst and enables the use of a lower catalyst loading.

The regular structure that can be achieved with a catalyst support made from vertically aligned carbon nanofibers may also improve mass transport, particularly on the anode side where the problem of gas bubbles in water blocking the transport may occur. The nanofiber spacing can also be precisely controlled during manufacture. This makes it possible to optimize both the void fraction and the size of the voids in such a catalyst support material.

One reason for carbon materials such as carbon nanofibers being used in catalyst supports is their chemical stability even under harsh conditions. PECVD-grown carbon nanofibers can be expected to show adequate chemical stability under conditions where carbon cloth or carbon black are used today, such as at the cathode side of an electrolyzer cell. Carbon nanofibers can also be coated with layers of even more chemically stable materials such as titanium, titanium nitride, iridium, niobium, or platinum, for example through atomic layer deposition. This enables the use of carbon nanofiber-based structures also on the anode side of water electrolyzer cells, where the chemical conditions typically require using metals or metal oxides in catalyst supports and porous transport layers.

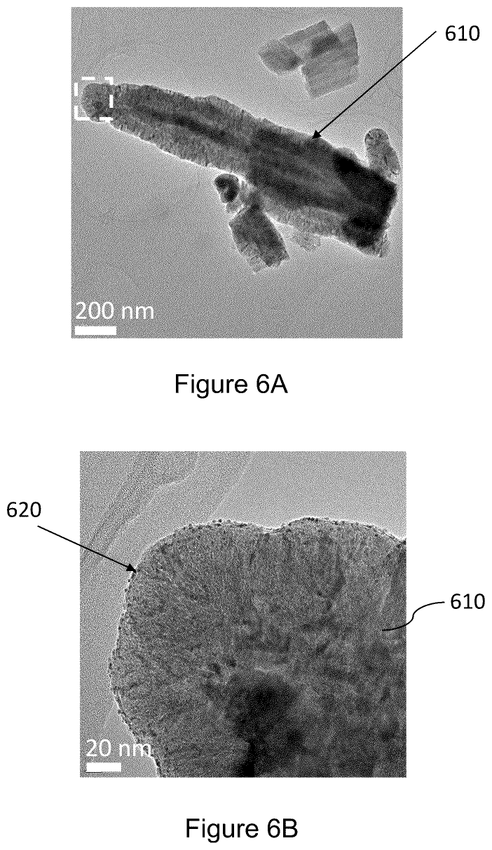

FIGS. 6A and B show transmission electron microscope, TEM, images of a carbon nanofiber 610. FIG. 6A shows the entire nanofiber while FIG. 6B shows a part of the nanofiber on which iridium nanoparticles 620 are visible as black dots.

FIG. 4 shows an electrolyzer 400 comprising a first and a second electrode, and an ion exchange membrane 430 arranged in-between the first and the second electrode.

Each electrode comprises a conductive element 413, 423 and at least one of the electrodes comprises a catalyst structure 200. The catalyst structure comprises a plurality of elongated nanostructures 221 arranged to connect the conductive element 413, 423 to a corresponding plurality of catalyst particles 222, where each catalyst particle 222 is localized at an end of a respective elongated nanostructure 221 opposite from the conductive element 413, 423.

For the elongated nanostructures 221 to effectively connect the conductive element 413, 423 to the catalyst particles 222, it is advantageous to have them extend from the conductive element 413, 423 in a uniform direction. Thus, the elongated nanostructures 221 may extend generally along respective axes 230, as shown in FIG. 2, where the axes are oriented in parallel to each other and extended substantially perpendicularly to the substrate 210, which in this case is the conductive element 413, 423.

For the electrolyzer to operate efficiently, ions must be able to enter the ion exchange membrane from the catalyst surface where the chemical reactions take place, which requires the catalyst particles to be in close proximity to the ion exchange membrane 430. For example, the catalyst particles 221 may be positioned less than one micrometer from the ion exchange membrane 430, or alternatively less than 10 nm from the ion exchange membrane 430, and preferably less than 5 nm from the ion exchange membrane. As another alternative, the electrocatalyst particles 222 may be positioned in contact with the ion exchange membrane 430.

According to yet other aspects, the catalyst particles 222 may be distributed such that the number of catalyst particles per unit volume is highest less than one micrometer from the ion exchange membrane and decreases as the distance from the ion exchange membrane increases.

It should be noted that the surface of the ion exchange membrane may exhibit surface structure, such as pores, grooves, and ridges, on a scale that is larger than the size of the catalyst particles. In this case, the distance between a catalyst particle and the ion exchange membrane surface is taken to be the shortest distance to the ion exchange membrane surface in any direction.

When considering the flow of water and gases through the catalyst structure, it should be noted that closely spaced elongated nanostructures may impede the water flow, but an increase in the number of catalyst particles per unit area of the ion exchange membrane 430 may be beneficial as it would make a larger amount of electrolysis catalyst available for the electrolysis reactions. Therefore, it is advantageous to use a branched nanostructure such as the one shown schematically in FIG. 2B. Each branch of the nanostructure has one catalyst particle localized at one end, in proximity to the ion exchange membrane. As each nanostructure has multiple branches, this means that the number of catalyst particles per unit area of the ion exchange membrane 430 can be increased without placing the elongated nanostructures more closely together. Thus, with reference to FIG. 2B, at least one of the elongated nanostructures 221 may be a branched nanostructure comprising a trunk 241 and at least two branches 242, where an electrocatalyst particle 222 is localized at the end of each branch 242.

The catalyst structure 200 must also allow a sufficient flow of water and of oxygen and hydrogen gas to and from the catalyst particles and the ion exchange membrane. To improve the flow of water and gases it may be advantageous to use other structures in addition to the elongated nanostructures. As an example, the catalyst structure 200 may comprise a porous carbon material. A porous carbon material could for example be carbon microfiber cloth or carbon paper. This porous carbon material may be placed adjacent to the conductive element 413, 423, with elongated nanostructures 221 extending from the porous carbon material towards the ion exchange membrane 430. The porous carbon material may be a porous transport layer as previously described.

With reference to FIG. 5A and FIGS. 1 and 4, there is also disclosed a method of producing a catalyst structure 200 for an electrolyzer 100, 400. The electrolyzer 100, 400 comprises a first and a second electrode and an ion exchange membrane 130, 430 arranged in-between the first and the second electrode. Each electrode comprises a conductive element 113, 123, 413, 423. The method comprises generating SA1 a plurality of elongated nanostructures 221, where the elongated nanostructures 221 are connected to the conductive element 113, 123, 413, 423 comprised in the first or second electrode. The method also comprises attaching SA2 a plurality of electrocatalyst particles 222 to the plurality of elongated nanostructures 221 such that each electrocatalyst particle 222 is localized at an end of a respective elongated nanostructure 221 opposite from the conductive element 113,123, 413, 423 comprised in the first or second electrode.

Attaching SA2 catalyst particles 222 to elongated nanostructures 221 may be accomplished through methods such as sputtering, spray coating, dip coating, atomic layer deposition, chemical vapor deposition, or other methods.

Elongated nanostructures 221 may be generated through lithographic methods such as colloidal lithography or nanosphere lithography, focused ion beam machining and laser machining, among other methods. For nanofibers comprising carbon or organic compounds, methods such as electrospinning or chlorination of carbides such as titanium carbide or metalloorganic compounds such as ferrocene may also be used.

According to aspects, generating SA1 a plurality of elongated nanostructures 221 may comprise growing SA11 the elongated nanostructures 221 on a substrate. The substrate may be one of the conductive elements 113, 123, 413, 423 comprised in the first or second electrode, a porous transport layer 112, 122, or some other substrate.

Growing SA11 elongated nanostructures 221 on a substrate allows extensive tailoring of the properties of the nanostructures. For instance, the growth conditions may be selected to increase the surface area of each nanostructure. According to aspects, the elongated nanostructures may be grown in a plasma.

The substrate may comprise materials such as silicon, glass, stainless steel, ceramics, silicon carbide, or any other suitable substrate material. The substrate may also comprise high temperature polymers such as polyimide. Optionally, the substrate may be a component of the electrolyzer 100, 400 such as a conductive plate 113, 123, 413, 423, a porous transport layer 112, 122, or the ion exchange membrane 130, 430.

Growing SA11 the elongated nanostructures 221 on a substrate may comprise depositing a growth catalyst layer on a surface of the substrate and growing the elongated nanostructures 221 on the growth catalyst layer.

Herein, a growth catalyst is a substance that is catalytically active and promotes the chemical reactions comprised in the formation of nanostructures.

The growth catalyst may comprise materials such as nickel, iron, platinum, palladium, nickel-silicide, cobalt, molybdenum, gold, or alloys thereof. As an example, the growth catalyst layer may be between 1 and 100 nm thick. As another example, the growth catalyst layer may comprise a plurality of particles of growth catalyst.

Growing SA11 the elongated nanostructures 221 on the growth catalyst layer may comprise heating the growth catalyst layer to a temperature where nanostructures can form and providing a gas comprising a reactant in such a way that the reactant comes into contact with the growth catalyst layer. Here, the reactant is a chemical compound or mix of chemical compounds that comprises the chemical elements used to form the nanostructure. For a carbon nanostructure, the reactant may comprise a hydrocarbon such as methane or acetylene, or it may comprise carbon monoxide.

According to aspects, the growth catalyst materials and the parameters of the growth process may be selected to achieve so-called tip growth of the nanostructures. During tip growth, a nanostructure will grow beneath a section of the growth catalyst, resulting in an elongated nanostructure with a remaining particle of growth catalyst at the tip of the elongated nanostructure.

Attaching SA2 catalyst particles 222 to the elongated nanostructures 221 may be accomplished using the remaining particle of growth catalyst. As an example, chemical elements present in the remaining particle of growth catalyst may be replaced with other chemical elements through methods such as galvanic replacement. As another example, the remaining particle of growth catalyst may be selectively coated with an electrolysis catalyst material suitable for use in the electrolyzer 100, 400.

According to aspects, depositing a growth catalyst layer may comprise spin coating the surface of the substrate with particles of growth catalyst. According to other aspects, depositing a growth catalyst layer comprises depositing a uniform growth catalyst layer and introducing a pattern onto the deposited uniform growth catalyst layer. Introducing a pattern onto the deposited uniform growth catalyst layer could comprise altering the thickness of the growth catalyst layer according to a pattern, or selectively removing the growth catalyst layer in some places. Introducing a pattern onto the growth catalyst layer may for example be accomplished through lithographic methods such as colloidal or nanosphere lithography. The patterning of the growth catalyst layer makes it possible to control the density of nanostructures per surface area on the substrate.

Growing SA11 the elongated nanostructures 221 on a substrate may also comprise depositing a conducting layer on a surface of the substrate. The growth catalyst layer may then be deposited on top of the conducting layer. After growing the elongated nanostructures, parts of the conductive layer that extend between or around the elongated nanostructures may be selectively removed. This removal may for example be accomplished through etching, e.g., plasma etching, pyrolysis etching or electrochemical etching.

The conducting layer electrically grounds the substrate, which is an advantage for certain methods of nanostructure growth such as growth in a plasma. It may also prevent the diffusion of atoms between the growth catalyst layer and the substrate.

According to aspects, the conducting layer may be between 1 and 100 microns thick.

According to aspects, additional layers may be present in addition to the substrate, the growth catalyst layer, and the conducting layer. The materials comprised in the additional layers may be selected to tune properties of the grown nanostructures, facilitate vertically oriented growth, or otherwise improve the result of the growth process. The additional layers may also comprise a conducting element 113, 123, 413, 423 or a porous transport layer 112, 122 forming part of an electrode for an electrolyzer 100, 400.

According to aspects, depositing any layer including the conducting layer and the growth catalyst layer may be carried out by methods such as evaporating, plating, sputtering, molecular beam epitaxy, pulsed laser depositing, chemical vapor deposition, spin-coating, spray-coating, or other suitable methods.

As an example, producing a catalyst structure 200 may comprise generating SA1 elongated nanostructures by depositing a conducting layer on an upper surface of a substrate; depositing a layer of growth catalyst on the conducting layer; growing the elongated nanostructures 221 on the layer of growth catalyst; and selectively removing the conducting layer between and around the elongated nanostructures. It may also comprise attaching SA2 catalyst particles 222 to the elongated nanostructures following the growth process.

According to aspects, the elongated nanostructures may be grown on a substrate comprising a component of the electrolyzer 100, 400, such as one of the conductive elements 113, 123, 413, 423, a porous transport layer 112, 122, or the ion exchange membrane 130, 430. According to other aspects, the elongated nanostructures may be grown on some other substrate and subsequently transferred onto for example one of the conductive elements 113, 123, 413, 423, a porous transport layer 112, 122, or the ion exchange membrane 130, 430.

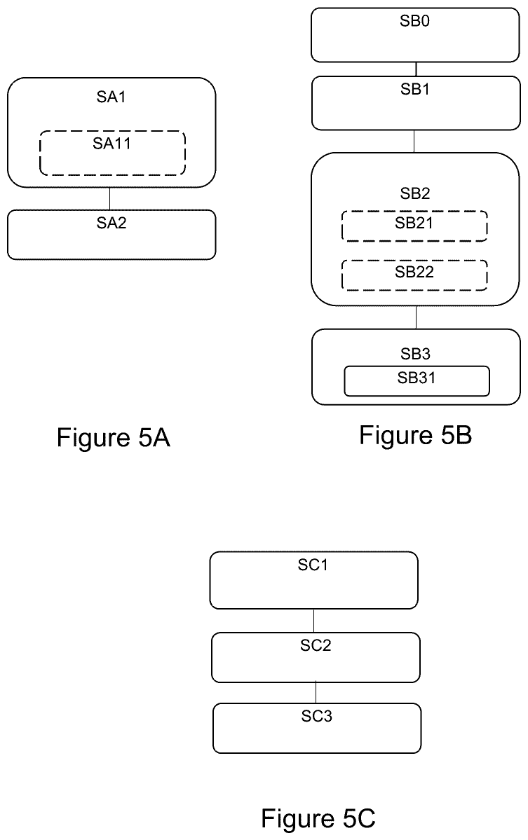

FIG. 5B shows a method of producing a catalyst structure 200 for an electrolyzer 100, 400. The electrolyzer 100, 400 comprises a first and a second electrode, and an ion exchange membrane 130, 430 arranged in-between the first and the second electrode. Each electrode comprises a conductive element 113, 123, 413, 423. The method comprises configuring SB0 a substrate having a surface. The substrate may be one of the conductive elements 113, 123, 413, 423 comprised in the first or second electrode, a porous transport layer 112, 122, or some other substrate. The method further comprises selecting SB1 a growth catalyst for the growth of elongated nanostructures 221 on the substrate, such that the growth catalyst can also be used as an electrolysis catalyst in the electrolyzer 100, 400, and depositing SB2 a growth catalyst layer comprising the selected growth catalyst on the surface of the substrate. Furthermore, the method comprises generating SB3 elongated nanostructures 221 with an electrocatalyst particle 222 suitable for use in an electrolyzer 100, 400 localized at an end of each elongated nanostructure 221 by growing elongated nanostructures 221 on the growth catalyst layer.

In addition to the previously described advantages of growing elongated nanostructures on a substrate, such as being able to tailor the properties of the nanostructures, this method has the advantage of simplifying the production of the catalyst structure 200 by using the same material in the growth catalyst as in the electrolysis catalyst particles 222. Attaching catalyst particles to the elongated nanostructures is thus not done in a separate step.

The substrate may comprise materials such as silicon, glass, stainless steel, ceramics, silicon carbide, or any other suitable substrate material. The substrate may also comprise high temperature polymers such as polyimide.

The growth catalyst may comprise materials such as nickel, iron, platinum, palladium, nickel-silicide, cobalt, molybdenum, gold, or alloys thereof. As an example, the growth catalyst layer may be between 1 and 100 nm thick. As another example, the growth catalyst layer may comprise a plurality of particles of growth catalyst.

To select a growth catalyst that is also suitable for use as an electrolysis catalyst in an electrolyzer 100, 400, it is preferred to find materials that can successfully act as catalysts for both the growth process and the chemical reactions comprised in the electrolysis process. Examples of suitable materials may be platinum, palladium, and nickel, which are used both in growth catalysts for growing nanostructures and in electrolysis catalysts.

Growing SB31 the elongated nanostructures 221 on the growth catalyst layer may comprise heating the growth catalyst layer to a temperature where nanostructures can form and providing a gas comprising a reactant in such a way that the reactant comes into contact with the growth catalyst layer. Here, the reactant is a chemical compound or mix of chemical compounds that comprises the chemical elements used to form the nanostructure. For a carbon nanostructure, the reactant may comprise a hydrocarbon such as methane or acetylene, or it may comprise carbon monoxide.

According to aspects, the elongated nanostructures may be grown in a plasma.

According to aspects, the growth catalyst materials and the parameters of the growth process may be selected to achieve so-called tip growth of the nanostructures. During tip growth, a nanostructure will grow beneath a section of the growth catalyst, resulting in an elongated nanostructure with a remaining particle of growth catalyst at the tip of the elongated nanostructure.

As an example, a substrate may be configured SB0 to comprise one of the conductive elements 113, 123, 413, 423 of an electrolyzer electrode and a growth catalyst may be selected SB1 such that it can also be used as an electrolysis catalyst. If, after depositing SB2 the growth catalyst layer, the parameters of the growth process are tuned to achieve tip growth, growing SB31 elongated nanostructures on the growth catalyst layer will result in a plurality of elongated nanostructures attached to a conductive element with a catalyst particle localized at one end of each elongated nanostructure, opposite from the conductive element.

Depositing a growth catalyst layer SB2 may comprise depositing a uniform growth catalyst layer and introducing SB22 a pattern onto the deposited uniform growth catalyst layer. As previously mentioned, introducing a pattern onto the deposited uniform growth catalyst layer could comprise altering the thickness of the growth catalyst layer according to a pattern, or selectively removing the growth catalyst layer in some places. Introducing a pattern onto the growth catalyst layer may for example be accomplished through lithographic methods such as colloidal or nanosphere lithography. The patterning of the growth catalyst layer makes it possible to control the density of nanostructures per surface area on the substrate.

The method may also comprise depositing SB21 a conducting layer on the surface of the substrate. The growth catalyst layer may be deposited on top of the conducting layer. After growing the elongated nanostructures, parts of the conductive layer that extend between or around the elongated nanostructures may be selectively removed. This removal may for example be accomplished through etching, e.g., plasma etching, pyrolysis etching or electrochemical etching. According to aspects, the conducting layer may be between 1 and 100 microns thick.

The conducting layer electrically grounds the substrate, which is an advantage for certain methods of nanostructure growth such as growth in a plasma. It may also prevent the diffusion of atoms between the growth catalyst layer and the substrate.

According to aspects, additional layers may be present in addition to the substrate, the growth catalyst layer, and the conducting layer. The materials comprised in the additional layers may be selected to tune properties of the grown nanostructures, facilitate vertically oriented growth, or otherwise improve the result of the growth process. The additional layers may also comprise a conducting element 113, 123, 413, 423 forming part of an electrode for an electrolyzer 100, 400.

According to aspects, depositing any layer including the conducting layer and the growth catalyst layer may be carried out by methods such as evaporating, plating, sputtering, molecular beam epitaxy, pulsed laser depositing, chemical vapor deposition, spin-coating, spray-coating, or other suitable methods.

According to aspects, the elongated nanostructures may be grown on a substrate comprising a component of the electrolyzer 100, such as one of the conductive elements 113, 123, 413, 423, a porous transport layer 112, 122 or the ion exchange membrane 130, 430. According to other aspects, the elongated nanostructures may be grown on some other substrate and subsequently transferred onto for example one of the conductive elements 113, 123, 413, 423, a porous transport layer 112, 122, or the ion exchange membrane 130, 430.

With reference to FIG. 5C, there is also herein disclosed a method of producing a catalyst structure 200 for an electrolyzer 100, 400. The electrolyzer 100, 400 comprises a first and a second electrode, and an ion exchange membrane 130, 430 arranged in-between the first and the second electrode. Each electrode also comprises a conductive element 113, 123, 413, 423, and a catalyst layer 111, 121.

The method comprises generating SC1 a plurality of elongated nanostructures 221 and attaching SC2 a plurality of catalyst particles 222 to the plurality of elongated nanostructures 221. The method also comprises arranging SC3 the plurality of elongated nanostructures 221 to control a position of the plurality of electrocatalyst particles 222 relative to the ion exchange membrane 130, 430.

1. An electrolyzer comprising a first and a second electrode and an ion exchange membrane arranged in-between the first and the second electrode, each electrode comprising a conductive element and a catalyst layer, at least one catalyst layer comprising a catalyst structure, the catalyst structure comprising a plurality of elongated nanostructures and a plurality of electrocatalyst particles attached to the plurality of elongated nanostructures, wherein the plurality of elongated nanostructures is arranged to control a position of the plurality of electrocatalyst particles relative to the ion exchange membrane.

2. The electrolyzer according to claim 1, wherein the elongated nanostructures extend generally along respective axes, where the axes are oriented in parallel to each other and extend perpendicularly to the conductive element.

3. The electrolyzer according to claim 1, wherein the elongated nanostructures comprise carbon nanostructures.

4. The electrolyzer according to claim 1, where the elongated carbon nanostructures comprise any of: carbon nanofibers, carbon nanotubes, and/or carbon nanowires.

5. The electrolyzer according to claim 1, wherein at least one section of an elongated nanostructure is covered by a protective coating arranged to increase a resistance to corrosion.

6. The electrolyzer according to claim 5, wherein the protective coating comprises any of platinum, iridium, titanium, and titanium nitride, or a combination thereof.

7. The electrolyzer according to claim 1, wherein the elongated nanostructures are grown on a substrate comprising a component of the electrolyzer such as a conductive element or a porous transport layer.

8. The electrolyzer according to claim 7, wherein the substrate comprises a structured surface, and the elongated nanostructures are grown on the structured surface.

9. (canceled)

10. The electrolyzer according to claim 8, wherein a surface of the ion exchange membrane is arranged to follow a contour of the structured surface.

11. The electrolyzer according to claim 1, wherein at least one of the elongated nanostructures is arranged to extend at least partially into the ion exchange membrane.

12. The electrolyzer according to claim 11, wherein at least one electrocatalyst particle is affixed to a first section of the at least one elongated nanostructure, and wherein at least the first section of the at least one elongated nanostructure extends into the ion exchange membrane.

13. The electrolyzer according to claim 12, wherein the first section of the at least one elongated nanostructure is located at an end of the at least one elongated nanostructure opposite from the conductive element.

14. (canceled)

15. (canceled)

16. (canceled)

17. The electrolyzer according to claim 1, wherein at least one electrode comprises a porous transport layer arranged between the conductive element and the catalyst layer, and the porous transport layer comprises a porous material.

18. The electrolyzer according to claim 1, wherein the plurality of elongated nanostructures is arranged to connect the conductive element to the plurality of electrocatalyst particles, where each electrocatalyst particle is localized at an end of a respective elongated nanostructure opposite from the conductive element.

19. The electrolyzer according to claim 18, wherein the electrocatalyst particles are positioned less than 10 nm from the ion exchange membrane, and preferably less than 5 nm from the ion exchange membrane.

20. (canceled)

21. The electrolyzer according to claim 18, wherein the catalyst structure (200) comprises a porous carbon material.

22. (canceled)

23. A method of producing a catalyst structure for an electrolyzer, the electrolyzer comprising a first and a second electrode and an ion exchange membrane arranged in-between the first and the second electrode, where each electrode comprises a conductive element, the method comprising:
configuring (SB0) a substrate, such as one of the conductive elements comprised in the first or second electrode, a porous transport layer, or some other substrate, the substrate having a surface;
selecting (SB1) a growth catalyst for the growth of elongated nanostructures on the substrate, such that the growth catalyst can also be used as an electrolysis catalyst in the electrolyzer;
depositing (SB2) a growth catalyst layer comprising the selected growth catalyst on the surface of the substrate; and
generating (SB3) elongated nanostructures with an electrocatalyst particle suitable for use in an electrolyzer localized at an end of each elongated nanostructure by growing elongated nanostructures on the growth catalyst layer.

24. (canceled)

25. (canceled)

26. (canceled)

27. (canceled)

28. (canceled)

29. The method according to claim 23, where depositing a growth catalyst layer (SB2) comprises depositing a uniform growth catalyst layer and introducing (SB22) a pattern onto the deposited uniform growth catalyst layer.

30. The method according to claim 23, where depositing (SB2) a growth catalyst layer on the surface of the substrate comprises depositing (SB21) a conducting layer on the surface of the substrate.

31. A method of producing a catalyst structure for an electrolyzer, the electrolyzer comprising a first and a second electrode, and an ion exchange membrane arranged in-between the first and the second electrode, where each electrode comprises a conductive element, the method comprising:
generating (SC1) a plurality of elongated nanostructures;
attaching (SC2) a plurality of catalyst particles to the plurality of elongated nanostructures; and
arranging (SC3) the plurality of elongated nanostructures to control a position of the plurality of electrocatalyst particles relative to the ion exchange membrane.
